(19) United States
(12) Patent Application Publication
(10) Pub. No.: US 2006/0075296 A1
(43) Pub. Date: Apr. 6, 2006

(54) Method, apparatus and system for data integrity of state retentive elements under low power modes

(76) Inventors: Sankaran M. Menon, Austin, TX (US); Thomas J. Mozdzen, Gilbert, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/956,994

(22) Filed: Sep. 30, 2004

(51) Int. Cl. G06F 11/00

(52) U.S. Cl. 714/14

(57) ABSTRACT

In some embodiments, a method, apparatus and system for data integrity of state retentive elements under low power modes are generally presented. In this regard, an integrity agent is introduced to generate one or more error checking bits for content within a logic block in response to an indication associated with a request to enter a low power mode. Other embodiments are also disclosed and claimed.

### FIELD OF THE INVENTION

Embodiments of the present invention generally relate to the field of computing devices, and, more particularly to a method, apparatus and system for data integrity of state retentive elements under low power modes.

### BACKGROUND OF THE INVENTION

There has been an emphasis for electronic appliances, including computing and communication devices, to use less power in order to maximize battery life or to conserve resources. One way to use less power is to place a device in a low power mode when the device may not be doing anything useful. In some cases, state retentive elements within logic blocks, like flip-flops and latches, are expected to retain their previous contents after resuming from a low power mode. With power levels moving ever lower, there is a greater concern that data may become corrupted during low power modes.

### BRIEF DESCRIPTION OF THE DRAWINGS

The present invention is illustrated by way of example and not limitation in the figures of the accompanying drawings in which like references indicate similar elements, and in which:

FIG. 1 is a block diagram of an example electronic appliance suitable for implementing the integrity agent, in accordance with one example embodiment of the invention;

FIG. 2 is a block diagram of an example integrity agent architecture, in accordance with one example embodiment of the invention;

FIG. 3 is a block diagram of an example logic block with integrity agent implementation, in accordance with one example embodiment of the invention;

FIG. 4 is a block diagram of another example logic block with integrity agent implementation, in accordance with one example embodiment of the invention;

FIG. 5 is a block diagram of another example logic block with integrity agent implementation, in accordance with one example embodiment of the invention;

FIG. 6 is a flow chart of an example method for data integrity under low power mode, in accordance with one example embodiment of the invention; and

FIG. 7 is a block diagram of an example article of manufacture including content which, when accessed by a device, causes the device to implement one or more aspects of one or more embodiment(s) of the invention.

### DETAILED DESCRIPTION

Embodiments of the present invention are generally directed to a method, apparatus and system for data integrity of state retentive elements under low power modes. In this regard, in accordance with but one example implementation of the broader teachings of the present invention, an integrity agent is introduced. In accordance with but one example embodiment, the integrity agent employs an innovative method to generate one or more error checking bits for content within a logic block in response to an indication associated with a request to enter a low power mode. According to one example method, the integrity agent may shift contents within a logic block into an error checking unit. According to another example method, the integrity agent may generate error checking bits through circuitry built around contents within a logic block.

In the following description, for purposes of explanation, numerous specific details are set forth in order to provide a thorough understanding of the invention. It will be apparent, however, to one skilled in the art that embodiments of the invention can be practiced without these specific details. In other instances, structures and devices are shown in block diagram form in order to avoid obscuring the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

FIG. 1 is a block diagram of an example electronic appliance suitable for implementing the integrity agent, in accordance with one example embodiment of the invention. Electronic appliance 100 is intended to represent any of a wide variety of traditional and non-traditional electronic appliances, laptops, cell phones, wireless communication subscriber units, wireless communication telephony infrastructure elements, personal digital assistants, set-top boxes, or any electric appliance that would benefit from the teachings of the present invention. In accordance with the illustrated example embodiment, electronic appliance 100 may include one or more of processor(s) 102, memory controller 104, integrity agent 106, system memory 108, input/output controller 110, and input/output device(s) 112 coupled as shown in FIG. 1. Integrity agent 106, as described more fully hereinafter, may well be used in electronic appliances of greater or lesser complexity than that depicted in FIG. 1. Also, the innovative attributes of integrity agent 106 as described more fully hereinafter may well be embodied in any combination of hardware and software.

Processor(s) 102 may represent any of a wide variety of control logic including, but not limited to one or more of a microprocessor, a programmable logic device (PLD), programmable logic array (PLA), application specific integrated circuit (ASIC), a microcontroller, and the like, although the present invention is not limited in this respect.

Memory controller 104 may represent any type of chipset or control logic that interfaces system memory 108 with the other components of electronic appliance 100. In one embodiment, the connection between processor(s) 102 and memory controller 104 may be referred to as a front-side bus. In another embodiment, memory controller 104 may be referred to as a north bridge.

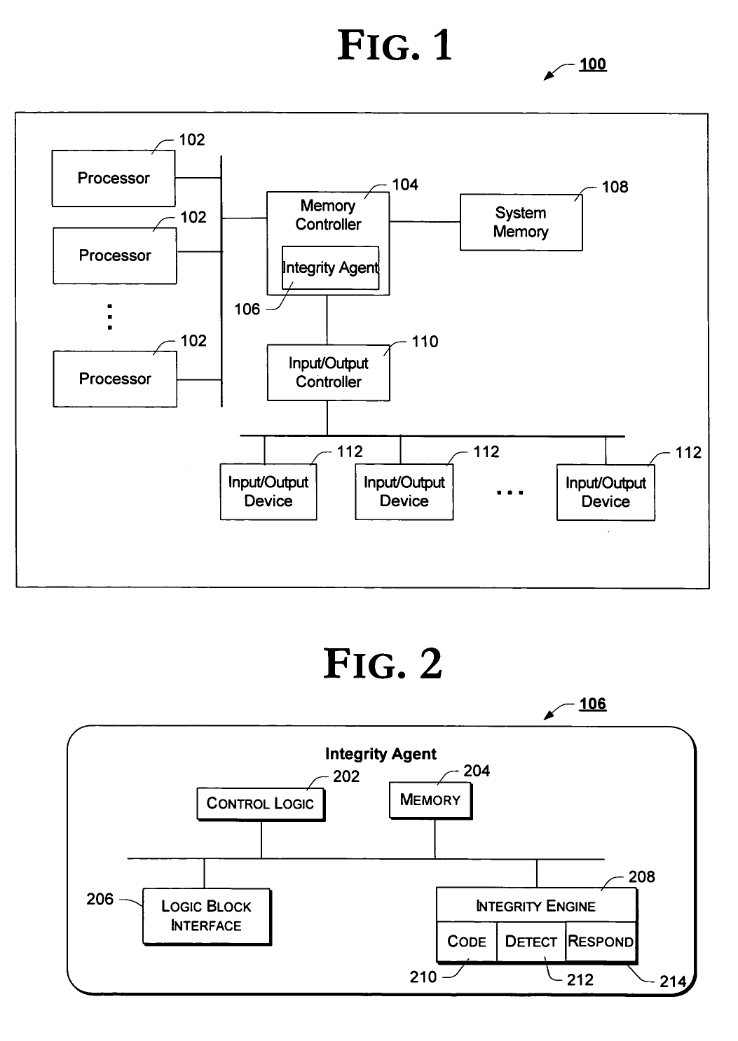

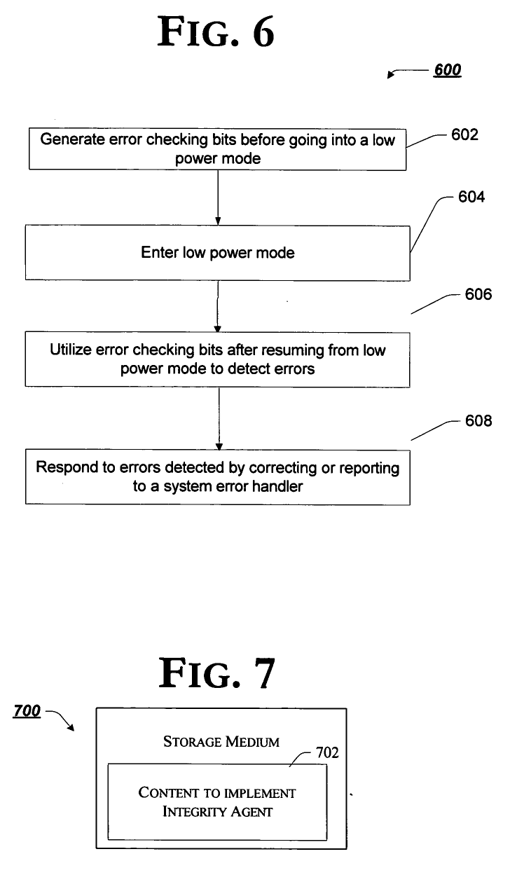

Integrity agent 106 may have an architecture as described in greater detail with reference to FIG. 2. Integrity agent 106 may also perform one or more methods for data integrity under low power mode, such as the method described in greater detail with reference to FIG. 6. While shown as being part of memory controller 104, integrity agent 106 may well be part of another component, for example processor(s) 102, or may be implemented in software or a combination of hardware and software.

System memory 108 may represent any type of memory device(s) used to store data and instructions that may have been or will be used by processor(s) 102. Typically, though the invention is not limited in this respect, system memory 108 will consist of dynamic random access memory (DRAM). In one embodiment, system memory 108 may consist of Rambus DRAM (RDRAM). In another embodiment, system memory 108 may consist of double data rate synchronous DRAM (DDRSDRAM). The present invention, however, is not limited to the examples of memory mentioned here.

Input/output (I/O) controller 110 may represent any type of chipset or control logic that interfaces I/O device(s) 112 with the other components of electronic appliance 100. In one embodiment, I/O controller 110 may be referred to as a south bridge.

Input/output (I/O) device(s) 112 may represent any type of device, peripheral or component that provides input to or processes output from electronic appliance 100. In one embodiment, though the present invention is not so limited, at least one I/O device 112 may be a network interface controller.

FIG. 2 is a block diagram of an example integrity agent architecture, in accordance with one example embodiment of the invention. As shown, integrity agent 106 may include one or more of control logic 202, memory 204, logic block interface 206, and integrity engine 208 coupled as shown in FIG. 2. In accordance with one aspect of the present invention, to be developed more fully below, integrity agent 106 may include an integrity engine 208 comprising one or more of code services 210, detect services 212, and/or respond services 214. It is to be appreciated that, although depicted as a number of disparate functional blocks, one or more of elements 202-214 may well be combined into one or more multi-functional blocks. Similarly, integrity engine 208 may well be practiced with fewer functional blocks, i.e., with only detect services 212, without deviating from the spirit and scope of the present invention, and may well be implemented in hardware, software, firmware, or any combination thereof. In this regard, integrity agent 106 in general, and integrity engine 208 in particular, are merely illustrative of one example implementation of one aspect of the present invention. As used herein, integrity agent 106 may well be embodied in hardware, software, firmware and/or any combination thereof.

As introduced above, integrity agent 106 may have the ability to generate one or more error checking bits for content within a logic block in response to an indication associated with a request to enter a low power mode. In one embodiment, integrity agent 106 may shift contents within a logic block into an error checking unit. In another embodiment, integrity agent 106 may generate error checking bits through circuitry built around contents within a logic block.

As used herein control logic 202 provides the logical interface between integrity agent 106 and its host electronic appliance 100. In this regard, control logic 202 may manage one or more aspects of integrity agent 106 to provide a control interface for electronic appliance 100 to initiate data integrity actions, e.g., through memory controller 104 or through processor(s) 102 in the event of a request to enter low power mode.

According to one aspect of the present invention, though the claims are not so limited, control logic 202 may receive event indications such as, e.g., request to enter a low power mode. Upon receiving such an indication, control logic 202 may selectively invoke the resource(s) of integrity engine 208. As part of an example method for data integrity under low power mode, as explained in greater detail with reference to FIG. 6, control logic 202 may selectively invoke code services 210 that may generate an error checking code comprising one or more bits. Control logic 202 also may selectively invoke detect services 212 or respond services 214, as explained in greater detail with reference to FIG. 6, to detect errors after resuming from low power mode or respond to errors detected, respectively. As used herein, control logic 202 is intended to represent any of a wide variety of control logic known in the art and, as such, may well be implemented as a microprocessor, a micro-controller, a field-programmable gate array (FPGA), application specific integrated circuit (ASIC), programmable logic device (PLD) and the like. In some implementations, control logic 202 is intended to represent content (e.g., software instructions, etc.), which when executed implements the features of control logic 202 described herein.

Memory 204 is intended to represent any of a wide variety of memory devices and/or systems known in the art. According to one example implementation, though the claims are not so limited, memory 204 may well include volatile and non-volatile memory elements, possibly random access memory (RAM) or read only memory (ROM), including flash memory. Memory 204 may be used to store error checking bits, for example.

Logic block interface 206 provides a path through which integrity agent 106 can interface with the contents of a logic block, for example memory controller 104.

As introduced above, integrity engine 208 may be selectively invoked by control logic 202 to generate an error checking code, to detect if an error has occurred, or to respond to errors detected. In accordance with the illustrated example implementation of FIG. 2, integrity engine 208 is depicted comprising one or more of code services 210, detect services 212 and respond services 214. Although depicted as a number of disparate elements, those skilled in the art will appreciate that one or more elements 210-214 of integrity engine 208 may well be combined without deviating from the scope and spirit of the present invention.

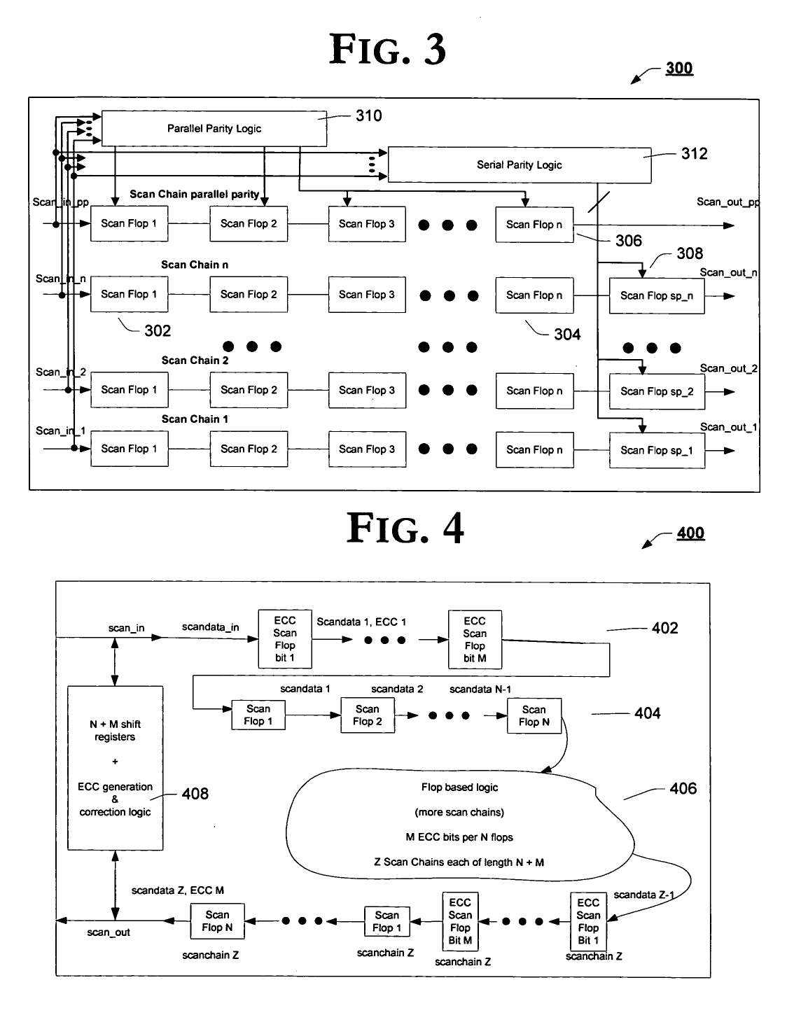

Code services 210, as introduced above, may provide integrity agent 106 with the ability to generate an error checking code comprising one or more bits. In one example embodiment, code services 210 may utilize a series of exclusive or (XOR) gates to generate a single error checking (or parity) bit for the contents of a series of flip-flops. In one example embodiment, as shown in FIG. 3, where logic block flip-flops are aligned in a grid, code services 210 may generate a serial parity bit for each row of flops and a parallel parity bit for each column of flops. In another example embodiment, code services 210 may utilize any code known in the art that can perform single error correction, double error detection (SECDEC).

As introduced above, detect services 212 may provide integrity agent 106 with the ability to detect if an error has occurred. In one example embodiment, detect services 212 may regenerate parity bits and compare the new parity bits to the parity bits stored before entering low power mode. In another example embodiment, detect services 212 may perform parity checks on the stored contents and error checking and correction (ECC) code to determine if an error occurred.

Respond services 214, as introduced above, may provide integrity agent 106 with the ability to respond to a detected error. In one embodiment, respond services 214 may be able to correct a single bit error. In another example embodiment, respond services 214 may report errors that can not be corrected to a system error handler, which may be software executed by processor(s) 102.

FIG. 3 is a block diagram of an example logic block with integrity agent implementation, in accordance with one example embodiment of the invention. As shown, logic block 300 may include one or more of scan flop columns 302, scan flop rows 304, parallel parity scan chain 306, serial parity flops 308, parallel parity logic 310, and serial parity logic 312 coupled as shown in FIG. 3.

While shown as a grid of n scan flops 304 per row and n scan flops 302 per column, the actual number of flops is not limited nor is it essential that the grid of flops be square. In this example, the first scan flop in each of the n rows may be connected through parallel parity logic 310 that can be utilized to generate a parallel parity bit that is stored in the first scan flop of parallel parity scan chain 306. Also, at the end of each row there may be a serial parity flop 308 that can store a parity bit that is generated by serial parity logic 312 from all n scan flops within that row. By maintaining serial and parallel parity bits it may be possible to not only detect errors, but also to correct single bit errors based on the knowledge of the row and column in which the error is detected.

In another embodiment, instead of a single parallel parity bit for each column of flops and a single serial parity bit for each row of flops, there may instead be stored multiple bit codes, for example based on the Hamming code, for detecting and correcting bit errors in columns and/or rows. In this sense, the present invention is not limited to the embodiment depicted. Other embodiments for generating parity or ECC codes for columns and/or rows of flops would occur to one skilled in the art that do not deviate from the spirit of the present invention.

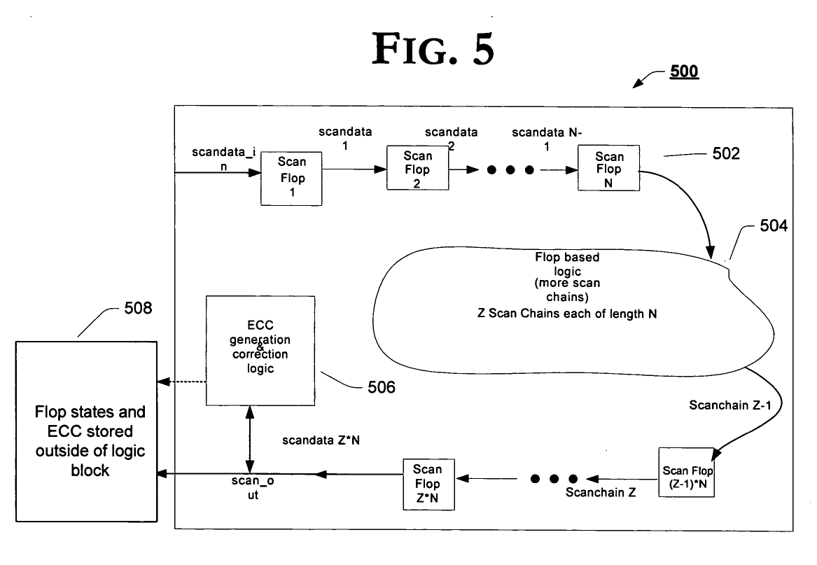

FIG. 4 is a block diagram of another example logic block with integrity agent implementation, in accordance with one example embodiment of the invention. As shown, logic block 400 may include one or more of ECC scan flops 402, scan flops 404, additional scan chains 406, and error checking unit 408 coupled as shown in FIG. 4.

As shown, for every N scan flops 404 of data, there are M ECC scan flops 402. In one example embodiment, N=64 and M=8, which one of ordinary skill in the art would recognize provides for single bit error correction and double bit error detection. The scan flops 404 and ECC scan flops 402, along with any additional scan chains 406, would be shifted N+M places into error checking unit 408 that would be capable of generating the ECC bits before entering a low power mode. The ECC bits and data bits would then be shifted back into ECC scan flops 402 and scan flops 404, respectively for storage under the low power mode. After resuming from low power mode the contents of scan flops 404 and ECC scan flops 402, along with any additional scan chains 406, would be shifted N+M places into error checking unit 408 again to detect if any errors have occurred. There are several possible embodiments which restore the data if a bad bit is found. In one embodiment, a parallel load of the scan chain (from error correcting unit 408 into scan flops 402 & 404) is performed to correct the data (extra wires for parallel load not shown). In another embodiment, the scan chain is on a separate clocking network so that the corrected data can be reloaded into the scan chain without affecting the contents of the remaining scan chain registers (clocking wires and control wires not shown).

FIG. 5 is a block diagram of another example logic block with integrity agent implementation, in accordance with one example embodiment of the invention. As shown, logic block 500 may include one or more of scan flops 502, additional scan chains 504, error checking unit 506, and storage 508 coupled as shown in FIG. 5. In this embodiment, the contents of scan flops 502 and additional scan chains 504 are shifted into error checking unit 506, which generates ECC bits. However, the results are then shifted into storage 508 for retention during low power mode, instead of being stored in logic block 500.

FIG. 6 is a flow chart of an example method for data integrity under low power mode, in accordance with one example embodiment of the invention. It will be readily apparent to those of ordinary skill in the art that although the following operations may be described as a sequential process, many of the operations may in fact be performed in parallel or concurrently. In addition, the order of the operations may be re-arranged without departing from the spirit of embodiments of the invention.

According to but one example implementation, the method of FIG. 6 begins with control logic 202 selectively invoking code services 210 to generate (602) error checking bits before going into a low power mode. In one example embodiment, control logic 202 receives a notification associated with a request to enter a low power state before invoking code services 210. Code services 210 may store one or more error checking bits generated in memory 204.

Next, electronic appliance 100 may enter (604) the low power mode. In one example embodiment, control logic 202 may issue a notification indicating that integrity agent 106 is ready to enter low power mode. In another example embodiment, code services 210 may assert a signal after generating the error checking bits.

Control logic 202 may then selectively invoke detect services 212 after resuming from low power mode to detect (606) errors. In one example embodiment, detect services 212 may invoke code services 210 to generate error checking bits, with which detect services 212 may compare to the error checking bits stored before entering low power mode. In another example embodiment, detect services 212 may determine the parity of sequences of data and ECC bits to determine if an error has occurred.

Next, respond services 214 may respond (608) to errors detected. In one embodiment, respond services 214 may correct errors within the scope of the error checking and correcting code employed. In another embodiment, respond services 214 may report detected errors outside its ability to correct to a system error handler.

FIG. 7 illustrates a block diagram of an example storage medium comprising content which, when accessed, causes an electronic appliance to implement one or more aspects of the integrity agent 106 and/or associated method 600. In this regard, storage medium 700 includes content 702 (e.g., instructions, data, or any combination thereof) which, when executed, causes the appliance to implement one or more aspects of integrity agent 106, described above.

The machine-readable (storage) medium 700 may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem, radio or network connection).

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Embodiments of the present invention may be used in a variety of applications. Although the present invention is not limited in this respect, the invention disclosed herein may be used in microcontrollers, general-purpose microprocessors, Digital Signal Processors (DSPs), Reduced Instruction-Set Computing (RISC), Complex Instruction-Set Computing (CISC), among other electronic components. However, it should be understood that the scope of the present invention is not limited to these examples.

Embodiments of the present invention may also be included in integrated circuit blocks referred to as core memory, cache memory, or other types of memory that store electronic instructions to be executed by the microprocessor or store data that may be used in arithmetic operations. In general, an embodiment using multistage domino logic in accordance with the claimed subject matter may provide a benefit to microprocessors, and in particular, may be incorporated into an address decoder for a memory device. Note that the embodiments may be integrated into radio systems or hand-held portable devices, especially when devices depend on reduced power consumption. Thus, laptop computers, cellular radiotelephone communication systems, two-way radio communication systems, one-way pagers, two-way pagers, personal communication systems (PCS), personal digital assistants (PDA's), cameras and other products are intended to be included within the scope of the present invention.

The present invention includes various operations. The operations of the present invention may be performed by hardware components, or may be embodied in machine-executable content (e.g., instructions), which may be used to cause a general-purpose or special-purpose processor or logic circuits programmed with the instructions to perform the operations. Alternatively, the operations may be performed by a combination of hardware and software. Moreover, although the invention has been described in the context of a computing appliance, those skilled in the art will appreciate that such functionality may well be embodied in any of number of alternate embodiments such as, for example, integrated within a communication appliance (e.g., a cellular telephone).

Many of the methods are described in their most basic form but operations can be added to or deleted from any of the methods and information can be added or subtracted from any of the described messages without departing from the basic scope of the present invention. Any number of variations of the inventive concept is anticipated within the scope and spirit of the present invention. In this regard, the particular illustrated example embodiments are not provided to limit the invention but merely to illustrate it. Thus, the scope of the present invention is not to be determined by the specific examples provided above but only by the plain language of the following claims.

What is claimed is:

1. A method comprising:
generating one or more error checking bits for content within a logic block in response to an indication associated with a request to enter a low power mode.

2. The method of claim 1, further comprising:
utilizing the error checking bits after resuming from the low power mode to determine if an error has occurred.

3. The method of claim 2, further comprising:
correcting errors detected.

4. The method of claim 2, further comprising:
reporting errors detected to a system error handler.

5. The method of claim 2, wherein generating one or more error checking bits for content within a logic block comprises:
serially shifting content within the logic block into an error checking unit.

6. The method of claim 2, wherein generating one or more error checking bits for content within a logic block comprises: performing serial and parallel exclusive or (XOR) functions on contents within the logic block.

7. An electronic appliance, comprising:
one or more input/output (I/O) devices;
at least one logic block, coupled with the one or more I/O devices; and
an integrity engine coupled with the logic block, the integrity engine to generate one or more error checking bits for content within the logic block in response to an indication associated with a request to enter a low power mode.

8. The electronic appliance of claim 7, further comprising:
the integrity engine to utilize the error checking bits after resuming from the low power mode to determine if an error has occurred.

9. The electronic appliance of claim 8, further comprising:
the integrity engine to correct errors detected.

10. The electronic appliance of claim 8, further comprising:
the integrity engine to report errors detected to a system error handler.

11. A storage medium comprising content which, when executed by an accessing machine, causes the accessing machine to generate one or more error checking bits for content within a logic block in response to an indication associated with a request to enter a low power mode.

12. The storage medium of claim 11, further comprising content which, when executed by the accessing machine, causes the accessing machine to utilize the error checking bits after resuming from the low power mode to determine if an error has occurred.

13. The storage medium of claim 12, further comprising content which, when executed by the accessing machine, causes the accessing machine to correct single bit errors and to report double bit errors to a system error handler.

14. The storage medium of claim 13, wherein the content to generate one or more error checking bits for content within a logic block comprises content which, when executed by the accessing machine, causes the accessing machine to perform serial and parallel exclusive or (XOR) functions on contents within the logic block.

15. The storage medium of claim 13, wherein the content to generate one or more error checking bits for content within a logic block comprises content which, when executed by the accessing machine, causes the accessing machine to serially shift content within the logic block into an error checking unit.

16. An apparatus, comprising:
a logic block; and
circuitry coupled with the logic block, the circuitry to generate and store one or more error checking bits for content within the logic block in response to an indication associated with a request to enter a low power mode.

17. The apparatus of claim 16, wherein the circuitry to generate one or more error checking bits comprises circuitry to serially shift content within the logic block into an error checking unit.

18. The apparatus of claim 17, further comprising circuitry to correct single bit errors and detect double bit errors.

19. The apparatus of claim 16, wherein the circuitry to generate one or more error checking bits comprises circuitry to generate serial and parallel error checking bits for contents within the logic block.

20. The apparatus of claim 19, further comprising circuitry to correct single bit errors and detect double bit errors.

21. The apparatus of claim 16, wherein the circuitry to generate one or more error checking bits comprises circuitry to generate serial error checking bits for rows of contents within the logic block.

22. The apparatus of claim 16, wherein the circuitry to generate one or more error checking bits comprises circuitry to generate parallel error checking bits for columns of contents within the logic block.
